(19) United States
(12) Patent Application Publication
(10) Pub. No.: US 2025/0337675 A1
(43) Pub. Date: Oct. 30, 2025

(54) SYSTEMS AND METHODS FOR MANAGING COMMUNICATIONS BETWEEN DEVICES USING A MANAGEMENT CONTROLLER

(71) Applicant: Dell Products L.P., Round Rock, TX (US)

(72) Inventors: LUIS ANTONIO VALENCIA REYES, Waxahachie, TX (US); ABEYE TESHOME, Austin, TX (US); RICHARD M. TONRY, Georgetown, TX (US); BASSEM EL-AZZAMI, Austin, TX (US); MOHIT ARORA, Frisco, TX (US); VINODKUMAR VASUDEV OTTAR, McKinney, TX (US); ADOLFO SANDOR MONTERO, Pflugerville, TX (US); RAJARAVI CHANDRA KOLLARAPU, Allen, TX (US)

(21) Appl. No.: 18/649,126

(22) Filed: Apr. 29, 2024

(51) Int. Cl. H04L 45/02; H04L 45/745

(52) U.S. Cl. CPC H04L 45/02; H04L 45/745

(57) ABSTRACT

Methods and systems for managing operations of a data processing system are disclosed. To manage operations of the data processing system, out-of-band components hosted by the data processing system may be utilized to facilitate transmission of data between devices not operably connected. To do so, a management controller of the data processing system may identify a point-to-point communication link associated with an identity of a dependent data processing system in which to forward data requests indicating the dependent data processing system to be the final destination. The management controller may forward the data request to the dependent data processing system via the point-to-point communication link to facilitate cooperative provisioning of computer-implemented services provided, at least in part, by the dependent data processing system.

### FIELD

Embodiments disclosed herein relate generally to managing data processing systems. More particularly, embodiments disclosed herein relate to systems and methods to manage communications between a network and non-network devices using at least a management controller.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a system in accordance with an embodiment.

FIG. 1B shows a block diagram illustrating a data processing system in accordance with an embodiment.

FIGS. 2A-2B show interaction diagrams in accordance with an embodiment.

FIGS. 3A-3B show flow diagrams illustrating a method of managing operation of a data processing system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of data processing systems. The data processing systems may provide computer-implemented services to any type and number of other devices and/or users of the data processing systems. The computer-implemented services may include any quantity and type of such services.

The data processing systems may operate in a distributed environment in which the computer-implemented services are cooperatively provided by entities throughout the distributed environment. To cooperatively perform the computer-implemented services, the entities (e.g., the data processing systems, servers, other devices) may exchange information (e.g., sensitive information) during any number of interactions.

However, the computer-implemented services may not be provided as desired (e.g., the sensitive information may be acquired by unauthorized entities) if the data processing systems and/or the interactions between the entities are disabled (e.g., due to lack of communication channels).

To establish communication between a non-network device and a network (and/or network device such as a server), the data processing system may generate a bridge of communications using out-of-band communication channel and a point-to-point communication link. By doing so, data communications between a network (and/or network based device) and a non-network device may be established and provide a communication channel even during inactivation of the data processing system (e.g., hardware resources and/or software resources of the data processing system).

In an embodiment, a method of managing operation of a data processing system is provided. The method may include: obtaining, by a management controller of the data processing system and via an out-of-band communication channel, a data request indicating that the management controller is an intermediate destination and a dependent data processing system operably connected to the management controller via a point-to-point communication link is a final destination; based on the management controller not being the final destination for the data request, identifying, by the management controller, the point-to-point communication link based on the dependent data processing system being the final destination; and forwarding, by the management controller and using the point-to-point communication link, the data request to the dependent data processing system to facilitate cooperative provisioning of a computer implemented service provided, at least in part, by the dependent data processing system.

The data processing system may include a network module adapted to separately advertise network endpoints for the management controller and hardware resources of the data processing system, the network endpoints being usable by a server to address communications to the hardware resources using an in-band communication channel and the management controller using the out-of-band communication channel.

The management controller and the network module are on separate power domains from the hardware resources so that the management controller and the network module are operable while the hardware resources are inoperable.

The out-of-band communication channel may run through the network module, and an in-band communication channel that services the hardware resources may also run through the network module.

The network module may host a transmission control protocol/internet protocol (TCP/IP) stack to facilitate network communications via the out-of-band communication channel.

The data request may be obtained from a remote cloud server, the remote cloud server and the data processing system being operably connected to each other via a network, and the remote cloud server is not operably connected to the dependent data processing system by any networks.

The intermediate destination may be a bridge for communications between the remote cloud server and the dependent data processing system.

Identifying the point-to-point communication link may include: obtaining, by the management controller, a payload from the data request; identifying, by the management controller, a header in the payload; using, by the management controller, presence of an identifier of the final destination in the payload; and based on the identifier, identifying the point-to-point communication link.

The point-to-point communication link may be identified by using the identifier as a key for a lookup, the lookup being performed using a lookup data structure that associates different final destinations with different point-to-point communication links, and the different point-to-point communication links operably connecting the management controller to dependent data processing systems.

The point-to-point communication link may be a direct communication link that allows transmission of information between the management controller and the dependent data processing system without using any networks.

The data request may include a payload, and a header identifying a first portion of the payload being additional control information indicating the final destination and a second portion of the payload being the requested data.

Forwarding the data request may include: extracting, by the management controller, the final destination from the payload to identify the point-to-point communication link associated with the final destination; removing, by the management controller, the header and the first portion of the payload to obtain a modified data request; and providing, by the management controller and via the out-of-band communication channel, the modified data request and the point-to-point communication link to a network module.

The method may also include: prior to obtaining the data request: obtaining, by the management controller and via the point-to-point communication link, an identity of the dependent data processing system; and providing, by the management controller and via the out-of-band communication channel, the identity of the dependent data processing system to a remote cloud server for facilitate future communication between the dependent data processing system and the remote cloud server even while the dependent data processing system and the remote cloud server are not connected via a network.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the method when the computer instructions are executed by the processor.

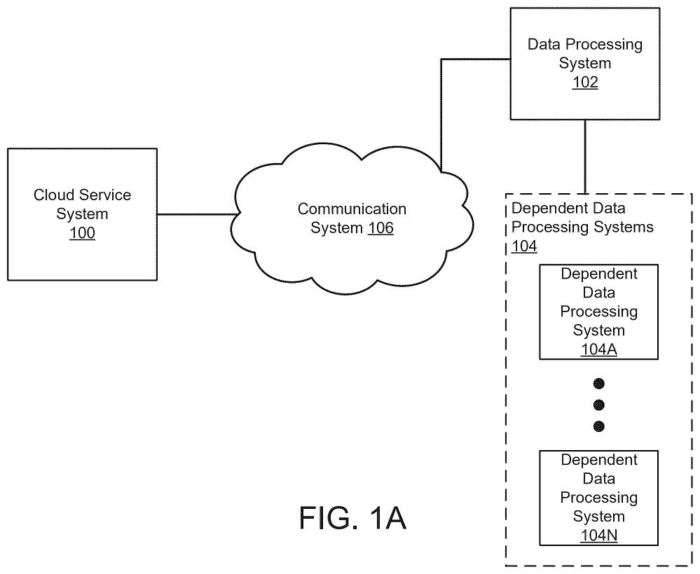

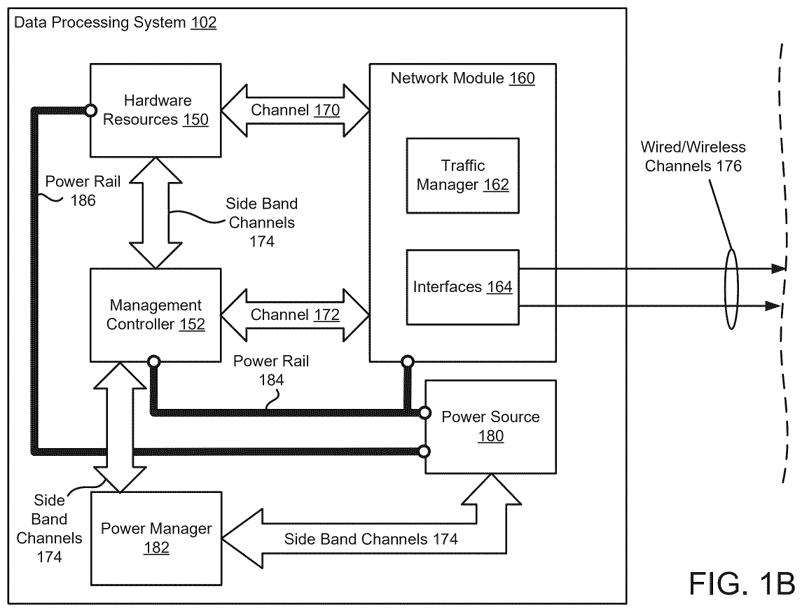

Turning to FIG. 1A, a block diagram illustrating a distributed environment in accordance with an embodiment is shown. The distributed environment (e.g., the system) shown in FIG. 1A may provide for management of operation of data processing systems that may provide, at least in part, computer-implemented services. The computer-implemented services may include any type and quantity of computer-implemented services. The computer-implemented services may include, for example, database services, data processing services, electronic communication services, and/or any other services that may be provided using one or more computing devices. The computer-implemented services may be provided by, for example, cloud service system 100, data processing system 102, dependent data processing systems 104 and/or any other type of devices (not shown in FIG. 1A). Other types of computer-implemented services may be provided by the system shown in FIG. 1A without departing from embodiments disclosed herein.

The system may include any number of dependent data processing systems 104 (e.g., endpoint devices) that may each include any number of hardware components (e.g., processors, memory modules, storage devices, communications devices). The hardware components may support execution of any number and types of applications (e.g., software components). Dependent data processing systems 104 may provide similar and/or different computer-implemented services and may provide the computer-implemented services independently and/or in cooperation with other devices. Changes in available functionalities of the hardware and/or software components may provide for various types of different computer-implemented services to be provided over time.

Operation of and/or computer-implemented services provided by a dependent data processing system (e.g., data processing system 104A) may be impacted (e.g., restricted and/or limited) based on an ability of the dependent data processing systems to operably connect with other computing devices. For example, in order to perform the computer-implemented services as desired, dependent data processing system 104A may require an active connection with a cloud based system (e.g., cloud service system 100), an active pairing with another device with an active connection to the cloud based system, etc. Thus, the computer-implemented services may not be provided as desired if dependent data processing systems 104 are unable to establish a connection with cloud service system 100 and/or other components of FIG. 1A.

For example, dependent data processing systems 104 may lack the capability (e.g., due to insufficient hardware resources, software components, etc.) to connect to a cloud-based system (e.g., cloud service system 100) via a network connection. Consequently, dependent data processing systems may rely on another computing device (capable of connecting to cloud service system 100 via a network) to serve as a proxy and/or communications bridge between cloud service system 100 and dependent data processing systems 104. For example, dependent data processing system 104A may include a wearable personal computing device, such as a smart watch, that may connect to another personal computing device, such as telephone, via a direct link (e.g., bluetooth connection), and therefore allowing transmission of data between cloud service system 100 and dependent data processing systems 104. Thus, operation of and/or computer-implemented services provided by dependent data processing systems 104 may depend on the available functionality of other devices (e.g., data processing system 102).

Consequently, the dependency on other devices by dependent data processing systems 104 may prevent performance of certain operations by the dependent data processing system. Continuing the example described above, the mobile device (e.g., data processing system 102) may not be functioning (e.g., due to failure of hardware components, powered off, etc.) and as such, may not connect to the smart watch (e.g., dependent data processing system 104A) and therefore, impacting (e.g., limiting, restricting, etc.) transmission of data between the smart watch and the cloud-based system.

In addition, the computer-implemented services may not be provided as desired if data processing system 102, other components of FIG. 1A, and/or interactions between the components are unreliable and/or untrustworthy. For example, data processing system 102 may be unreliable and/or untrustworthy when (i) hardware resources hosted by data processing system 102 may be compromised (e.g., by a malicious entity intending to access sensitive data), (ii) the hardware resources may lack connection to a network used to establish in-band communication channels for transmitting data to other devices, and/or (iii) limited functionality of the hardware resources to provide in-band communication channels between devices. Consequently, in the event data processing system 102 may be compromised, devices operably connected to data processing system 102 (e.g., indirectly and/or directly) may become compromised and, therefore, presenting security concerns for the devices and/or sensitive data stored thereon.

In general, embodiments disclosed herein relate to systems, devices, and methods for managing operations of a data processing system. To manage operations of a data processing system, a system in accordance with an embodiment may utilize a management controller hosted by the data processing system to establish a bridge for communications between devices not operably connected by any networks. To do so, the management controller may obtain an identity of a dependent data processing system using a point-to-point communication link and provide the identity to a remote cloud server using out-of-band communication channels in order to facilitate future communication between the dependent data processing system and remote cloud server.

By doing so, embodiments disclosed herein may facilitate continued provision of desired computer-implemented services by dependent data processing systems. By utilizing the out-of-band components of the data processing system, potentially compromised or inoperable in-band components may be circumvented, decreasing the likelihood of the transmitted data and/or the other devices (e.g., connected to the data processing system) of becoming compromised, and/or increasing the likelihood of the dependent data processing system providing desirable computer-implemented services to a user (e.g., operating the dependent data processing system).

To perform the above-mentioned functionality, the system of FIG. 1A may include cloud service system 100, data processing system 102, and/or dependent processing systems 104. Cloud service system 100, data processing system 102, dependent processing systems 104, and/or any other type of devices not shown in FIG. 1A may perform all, or a portion of the computer-implemented services independently and/or cooperatively. Each of these components is discussed below.

Data processing system 102 may provide desired computer implemented services and perform cooperative processes with cloud service system 100 and dependent data processing systems 104 to establish a bridge for communications between cloud service system 100 and dependent data processing systems 104. Data processing system 102 may include in-band components (e.g., hardware resources) and out-of-band components (e.g., a management controller), and functionality that may allow the out-of-band components to (i) communicate with one another independently from the in-band components, (ii) perform operations independently from the in-band components, and/or (iii) communicate with remote systems independently from the in-band components. For more information regarding components of data processing system 102, refer to the discussion of FIG. 1B.

While illustrated in FIG. 1A with a single data processing system 102, there may be any number of data processing systems that may facilitate communications with any number of other data processing systems. When providing the computer-implemented services, data processing system 102 may rely on the management controller to facilitate transmission of data between cloud service system 100 and dependent data processing systems 104. To facilitate transmission of data, the management controller may (i) obtain an identity of dependent data processing systems 104 using a direct communication link (e.g., a point-to-point communication link), (ii) perform a mapping process to associate identities of dependent data processing systems with their respective point-to-point communication links, (iii) provide the identity of the dependent data processing systems 104 to cloud service system 100, and/or (iv) may perform other operations. By doing so, data processing system 102 may facilitate future communications between devices not operably connected via any network (e.g., cloud service system 100 and dependent data processing systems 104) even while in-band components (e.g., hardware resources, software components, etc.) of data processing system 102 are not functional.

Dependent data processing systems 104 may provide desired computer-implemented services and perform cooperative processes with data processing system 102 to facilitate cooperative provisioning of the computer-implemented services provided by dependent data processing systems 104. Dependent data processing systems 104 may include any number and/or type of dependent data processing systems (e.g., 104A-1004N). Dependent data processing systems 104 may be operated by users and/or may provide computer-implemented services such as telemetry services, recovery services, etc. based on the users' operation. To perform its functionality, dependent data processing systems 104 may communicate (e.g., exchange data) with the out-of-band components of data processing system 102 using a direct communication link (e.g., point-to-point communication link) with data processing system 102. For example, dependent data processing systems 104 may use the point-to-point communication link to provide an identity (e.g., unique identifier) for the respective dependent data processing system to data processing system 102.

Cloud service system 100 may include any number and/or type of cloud service systems (e.g., other data processing systems, management systems, storage devices, user devices, etc.) that may provide computer-implemented services. To perform its functionality, cloud service system 100 may communicate (e.g., exchange data) with the out-of-band components of data processing system 102 using out-of-band communication channels. For example, cloud service system 100 may provide (at least in part) computer-implemented services via a management controller of data processing system 102 (e.g., bypassing any in-band components of data processing system 102).

To provide computer-implemented services, cloud service system 100 may, for example, (i) provide data requests to the management controller (e.g., via out-of-band communication channels), (ii) participate in authentication processes (e.g., in order to verify authenticity of devices such as dependent data processing systems 104), (iii) receive any type of data for dependent data processing systems 104 (e.g., secured data from management controller of data processing system 102 via out-of-band communication channels), and/or (iv) perform other actions that may facilitate computer-implemented services to be provided.

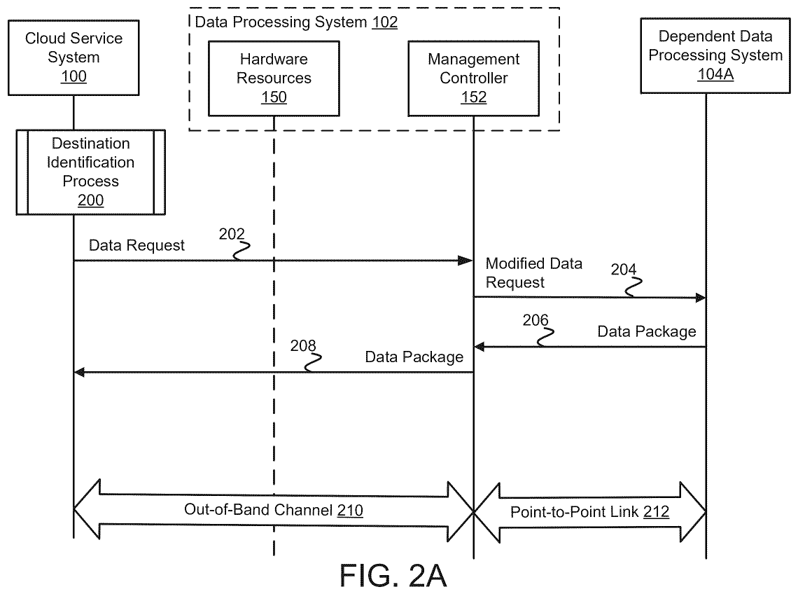

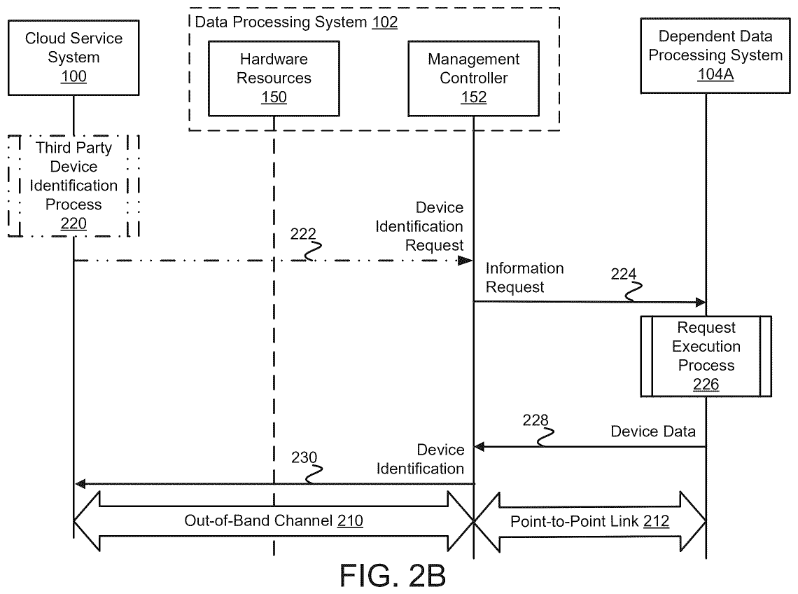

Refer to FIGS. 2A-2B for additional details regarding facilitating communications between devices not operably connected by any network.

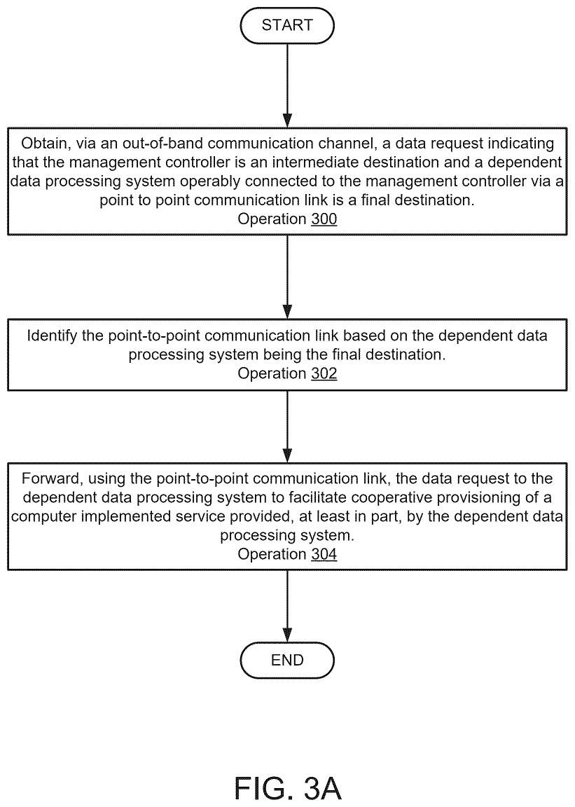

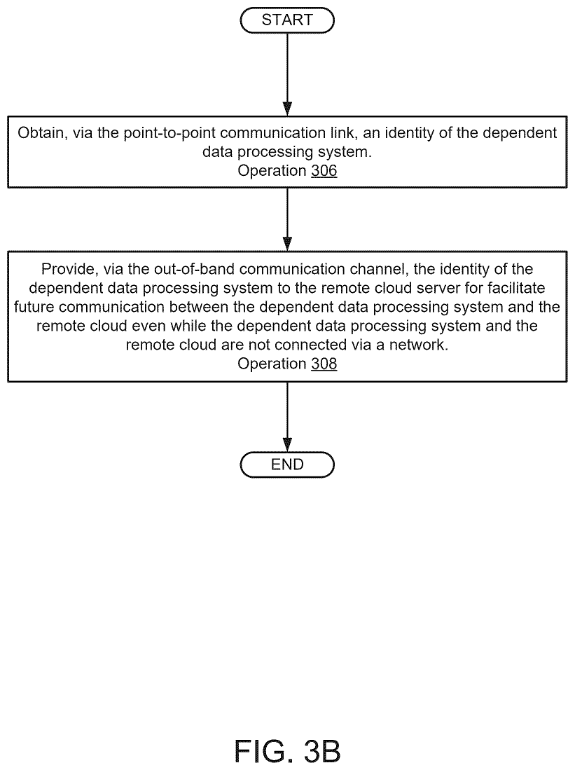

When providing their functionality, any of cloud service system 100, data processing system 102, and/or dependent data processing systems 104 may perform all, or a portion of the methods shown in FIGS. 2A-3B.

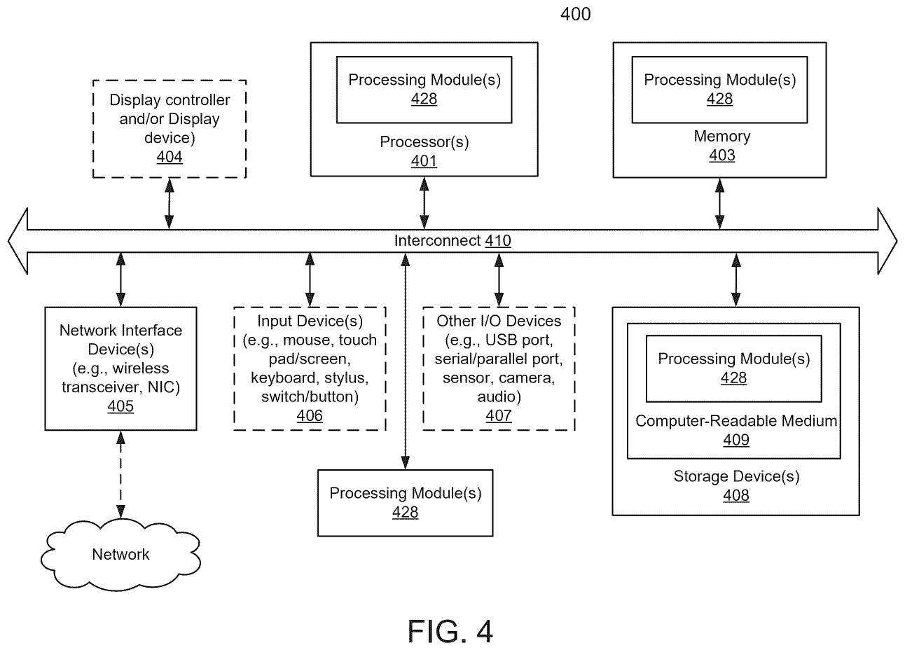

Any of (and/or components thereof) cloud service system 100, data processing system 102 and/or dependent data processing systems 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 1A may be operably connected to each other (and/or components not illustrated) with communication system 106.

Communication system 106 may include one or more networks that facilitate communication between any number of components. The networks may include wired networks and/or wireless networks (e.g., and/or the Internet). The networks may operate in accordance with any number and types of communication protocols (e.g., such as the internet protocol).

Communication system 106 may be implemented with one or more local communications links (e.g., a bus interconnecting a processor of any of data processing system 102 and cloud service system 100).

Communication system 106 may include out-of-band communication channels, in-band communication channels, and/or other types of communication channels.

Refer to FIG. 1B for additional details regarding the management controller, network module, in-band communication channel, out-of-band communication channel, and/or hardware resources of data processing system 102.

While illustrated in FIG. 1A as including a limited number of specific components, a system in accordance with an embodiment may include fewer, additional, and/or different components than those illustrated therein. For example, while the system of FIG. 1A shows a single cloud service system (e.g., 100), it will be appreciated that the system may include any number of cloud service systems.

Turning to FIG. 1B, a diagram illustrating data processing system 102 in accordance with an embodiment is shown. Data processing system 102 may be similar to any of data processing system 102 shown in FIG. 1A.

To provide computer-implemented services, data processing system 102 may include any quantity of hardware resources 150. Hardware resources 150 may be in-band hardware components, and may include a processor operably coupled to memory, storage, and/or other hardware components.

The processor may host various management entities such as operating systems, drivers, network stacks, and/or other software entities that provide various management functionalities. For example, the operating system and drivers may provide abstracted access to various hardware resources. Likewise, the network stack may facilitate packaging, transmission, routing, and/or other functions with respect to exchanging data with other devices.

For example, the network stack may support transmission control protocol/internet protocol communication (TCP/IP) (e.g., the Internet protocol suite) thereby allowing hardware resources 150 to communicate with other devices via packet switched networks and/or other types of communication networks.

The processor may also host various applications that provide the computer-implemented services. The applications may utilize various services provided by the management entities and use (at least indirectly) the network stack to communicate with other entities.

However, use of the network stack and the services provided by the management entities may place the applications at risk of indirect compromise. For example, if any of these entities trusted by the applications are compromised, these entities may subsequently compromise the operation of the applications. For example, if various drivers and/or the communication stack are compromised, communications to/from other devices may be compromised. If the applications trust these communications, then the applications may also be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 102) to another device via any number of intermediate networks (e.g., via wired/wireless channels 176 that are part of the networks).

In addition, different configurations of hardware resources 150 and/or software resources may be implemented by data processing system 102 based on the type of computer-implemented services that are to be provided. Modifications to configurations of hardware resources 150 and/or the software resources may lead to downtime for data processing system 102 and may consume network bandwidth of channel 170.

To reduce the downtime of data processing system 102 and to reduce the likelihood of the applications and/or other in-band entities from being indirectly compromised, data processing system 102 may include management controller 152 and network module 160. Each of these components of data processing system 102 is discussed below.

Management controller 152 may be implemented, for example, using a system on a chip or other type of independently operating computing device (e.g., independent from the in-band components, such as hardware resources 150, of a host data processing system 102). Management controller 152 may provide various management functionalities for data processing system 102. For example, management controller 152 may monitor various ongoing processes performed by the in-band components, may manage power distribution, thermal management, and/or other functions of data processing system 102.

To do so, management controller 152 may be operably connected to various components via side band channels 174 (in FIG. 1B, a limited number of side band channels are included for illustrative purposes, it will be appreciated that management controller 152 may communicate with other components via any number of side band channels). The side band channels may be implemented using separate physical channels, and/or with a logical channel overlay over existing physical channels (e.g., logical division of in-band channels). The side band channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, to reduce the likelihood of indirect compromise of an application hosted by hardware resources 150, management controller 152 may enable information from other devices to be provided to the application without traversing the network stack and/or management entities of hardware resources 150. To do so, the other devices may direct communications including the information to management controller 152. Management controller 152 may then, for example, send the information via side band channels 174 to hardware resources 150 (e.g., to store it in a memory location accessible by the application, such as a shared memory location, a mailbox architecture, or other type of memory-based communication system) to provide it to the application. Thus, the application may receive and act on the information without the information passing through potentially compromised entities. Consequently, the information may be less likely to also be compromised, thereby reducing the possibility of the application becoming indirectly compromised. Similar processes may be used to facilitate outbound communications from the applications.

Management controller 152 may be operably connected to communication components of data processing system 102 via separate channels (e.g., 172) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted component may not result in indirect compromise of any management controller 152, and entities hosted by management controller 152.

To facilitate communication with other devices, data processing system 102 may include network module 160. Network module 160 may provide communication services for in-band components and out-of-band components (e.g., management controller 152) of data processing system. Specifically, an out-of-band communication channel (e.g., 172) that services management controller 152 and an in-band communication channel (e.g., 170) that services hardware resources 150 may run through network module 160. Network module 160 may host a TCP/IP stack to facilitate network communications via the out-of-band communication channel. To do so, network module 160 may include traffic manager 162 and interfaces 164.

Traffic manager 162 may include functionality to (i) discriminate traffic directed to various network endpoints advertised by data processing system 102, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a WiFi card, a wireless local area network card, a wired local area network card, an optical communication card, a radio access network (RAN) card, a wide area network (WAN) card, and/or other types of communication components. These components may support any number of wired/wireless channels 176.

Thus, from the perspective of an external device, the in-band components and out-of-band components of data processing system 102 may appear to be two independent network entities, that may independently addressable, and otherwise unrelated to one another.

To facilitate management of data processing system 102 over time, hardware resources 150, management controller 152 and/or network module 160 may be positioned in separately controllable power domains. By being positioned in these separate power domains, different subsets of these components may remain powered while other subsets are unpowered.

For example, management controller 152 and network module 160 may remain powered while hardware resources 150 is unpowered. Consequently, management controller 152 may remain able to communication with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, data processing system 102 may include a power source (e.g., 180) that separately supplies power to power rails (e.g., 184, 186) that power the respective power domains. Power from the power source (e.g., a power supply, battery, etc.) may be selectively provided to the separate power rails to selectively power the different power domains. A power manager (e.g., 182) may manage power from power source 180 is supplied to the power rails (e.g., by providing instructions via side band channels 174). Management controller 152 may cooperate with power manager 182 to manage supply of power to these power domains. Management controller 152 may communicate with power manager 182 via side band channels 174 and/or via other means.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

When providing its functionality, components of data processing system 102 may perform all, or a portion, of the methods and operations illustrated in FIGS. 2A-3B.

While illustrated in FIG. 1B with a limited number of specific components, a system may include additional, fewer, and/or different components without departing from embodiments disclosed herein.

As discussed above, the components of FIGS. 1A-1B may perform various methods to manage secure communication between the cloud service system, data processing system and dependent data processing systems. FIGS. 2A-3B may illustrate examples of methods that may be performed by the components of FIGS. 1A-1B. For example, a management controller similar to management controller 152 and/or hardware resources similar to hardware resources 150 may perform all or a portion of the methods. In the diagrams discussed below and shown in FIGS. 2A-3B, any of the operations may be repeated, performed in different orders, and/or performed in parallel with or in a partially overlapping in time manner with other operations.

To further clarify embodiments disclosed herein, interaction diagrams in accordance with an embodiment are shown in FIGS. 2A-2B. These interaction diagrams may illustrate how data may be obtained and used within the system of FIGS. 1A-1B.

In the interaction diagrams, processes performed by and interactions between components of a system in accordance with an embodiment are shown. In the diagrams, components of the system are illustrated using a first set of shapes (e.g., hardware resources 150, management controller 152, cloud service system 100, etc.), located towards the top of each figure. Lines descend from these shapes. Processes performed by the components of the system are illustrated using a second set of shapes (e.g., destination identification process 200, etc.) superimposed over these lines. Interactions (e.g., communication, data transmissions, etc.) between the components of the system are illustrated using a third set of shapes (e.g., 204, 206, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

The lines descending from some of the first set of shapes (e.g., 150) is drawn in dashing to indicate, for example, that the corresponding components may not be (i) operable, (ii) powered on, (iii) present in the system, and/or (iv) not participating in operation of the system for other reasons.

Generally, the processes and interactions are temporally ordered in an example order, with time increasing from the top to the bottom of each page. For example, the interaction labeled as 206 may occur prior to the interaction labeled as 208. However, it will be appreciated that the processes and interactions may be performed in different orders, any may be omitted, and other processes or interactions may be performed without departing from embodiments disclosed herein.

Turning to FIG. 2A, a first interaction diagram in accordance with an embodiment is shown. The first interaction diagram may illustrate processes and interactions that may occur during communication of data between cloud service system 100, data processing system 102, and/or dependent data processing system 104A. As discussed with respect to FIGS. 1A-1B, data processing system 102 may include hardware resources 150 and management controller 152.

Prior to communicating data between cloud service system 100, data processing system 102, and/or dependent data processing system 104A, dependent data processing system 104A may be registered with cloud service system 100 via data processing system 102. By registering dependent data processing system 104A with cloud service system 100, cloud service system 100 may associate dependent data processing system 104A with management controller 152 (e.g., as an intermediate destination). Refer to FIG. 2B for additional details regarding registering dependent data processing systems.

To initiate data communication, cloud service system 100 may generate a data request including information regarding the data requested from an entity (e.g., dependent data processing system 104A). For example, the data request (e.g., generated by cloud service system 100) may include a request for portion of data collected, stored, and/or otherwise managed by a third party device (e.g., dependent data processing system 104A).

Cloud service system 100 may perform destination identification process 200 to obtain an identity of the intermediate destination (e.g., management controller 152) associated with the final destination (e.g., dependent data processing system 104A). Cloud service system 100 may perform destination identification process 200 in response to a request for data being generated (e.g., by cloud service system 100, an external entity, etc.), upon an occurrence of an event (e.g., an update process for dependent data processing system 104A) and/or for other reasons.

Destination identification process 200 may include performing a look up process, for example, using an identifier for the final destination (e.g., dependent data processing system 104A) as a key to identify the associated intermediate destination (e.g., management controller 152). Cloud service system 100 may perform the look up process using a lookup data structure that associates different final destinations (e.g., dependent data processing systems 104A) with different intermediate destinations (e.g., management controller 152). As a result of performing the lookup process, cloud service system 100 may obtain an identifier (e.g., IP protocol/address) for the intermediate destination (e.g., management controller 152). The intermediate destination may be a bridge for communications between cloud service system 100 and dependent data processing system 104A.

Once obtained, the identifier for management controller 152 may be used as part of generating the data request by cloud service system 100. Data request may include, for example, a data structure. The data structure may include: (i) a payload including the data requested and/or the identity of the final destination (e.g., dependent data processing system 104A), (ii) a header in the payload delineating which portions of the payload are intended as instruction for management controller 152 and the other portion being the data requested, (iii) control information indicating the intermediate destination (e.g., identity of management controller 152), and/or any other information necessary to provide the data request to the final destination via the intermediate destination. For example, the data request may include a payload, and a header that identifies a first portion of the payload as additional control information (e.g., indicating the final destination address) and a second portion of the payload as the requested data.

Following destination identification process 200 and at interaction 202, cloud service system 100 may provide the data request to management controller 152 via out-of-band channel 210. Out-of-band channel 210 may be similar to any of out-of-band channels 172 described in FIG. 1B.

For example, the data request may be provided to management controller 152 via (i) transmission via a message, (ii) storing in a storage with subsequent retrieval by management controller 152, (iii) via a publish-subscribe system where management controller 152 subscribes to updates from cloud service system 100 thereby causing a copy of the data request to be propagated to management controller 152, and/or via other processes.

Following receipt of the data request, management controller 152 may identify the header of the payload (e.g., identifying the first portion of the payload to include additional control information) and use the presence of an identifier of the final destination in the payload to identify the point-to-point communication link.

As part of managing interactions between cloud service system 100 and dependent data processing system 104A, management controller 152 may generate a modified data request to provide to dependent data processing system 104A. The modified data request may include a payload with the requested data and an identifier of the requesting entity (e.g., cloud service system 100). For example, generating the modified data request may include: (i) extracting, by management controller 152, the final destination from the payload to identify the point-to-point communication link associated with the final destination, (ii) removing, by management controller 152, the header and the first portion of the payload to obtain the modified data request, and/or any other processes.

Once generated, at interaction 204, the modified data request may be provided to dependent data processing system 104A. To do so, the identity of the final destination may be used to perform a lookup or other type of operation to identify a point-to-point link over which to transmit the modified data request to reach dependent data processing system 104A. The lookup process may be performed by using a lookup data structure that associates different final destinations with different point-to-point communication links, and the different point-to-point communication links operably connecting management controller 152 to dependent data processing systems. Point-to-point link 212 may include any type of direct communication link that allows transmission of information between management controller 152 and dependent data processing system 104A without using any networks. For example, point-to-point link 212 may include a bluetooth connection established between management controller 152 and dependent data processing system 104A. Once identified, the modified data request may be sent over the point-to-point link (e.g., point-to-point link 212).

To provide the modified data request to dependent data processing system 104A, management controller 152 may provide the modified data request and the point-to-point communication link to network module (e.g., network module 160 shown in FIG. 1B) via out-of-band communication channel (out-of-band channel 172 described in FIG. 1B) and instruct the network module to send the modified data request to dependent data processing system 104A using the identified point-to-point communication link (e.g., point-to-point link 212).

Following receipt of the modified data request, dependent data processing system 104A may generate a data package based on the requested data (e.g., specified via modified data request). The data package may include: (i) identifying data responsive to the modified data request, (ii) an identifier of the dependent data processing system, and/or (iii) any other information responsive to the modified data request.

Once generated, at interaction 206, the data package may be provided to management controller 152 via the point-to-point communication link (e.g., point-to-point link 212). For example, the data package may be provided to management controller 152 via (i) transmission via a message, (ii) storing in a storage with subsequent retrieval by management controller 152, (iii) via a publish-subscribe system where management controller 152 subscribes to updates from dependent data processing system 104A thereby causing a copy of the data package to be propagated to management controller 152, and/or via other processes.

Following receipt of the data package, at interaction 208, management controller 152 may provide the data package to cloud service system 100 using the out-of-band communication channel (e.g., out-of-band channel 210). For example, the data package may be provided to cloud service system 100 via (i) transmission via a message, (ii) storing in a storage with subsequent retrieval by cloud service system 100, (iii) via a publish-subscribe system where cloud service system 100 subscribes to updates from management controller 152 thereby causing a copy of the data package to be propagated to cloud service system 100, and/or via other processes.

Consequently, data may be communicated between a network (e.g., cloud service system 100) and a non-network device (e.g., dependent data processing system 104A) even if data processing system 102 is powered off and/or does not have an in-band communication via in-band components of data processing system 102.

Turning to FIG. 2B, a second interaction diagram in accordance with an embodiment is shown. The second diagram may illustrate processes and interactions that may occur during identification process of non-network devices (e.g., dependent data processing system 104A).

The lines forming around some of the second set of shapes (e.g., 220) and the third set of shapes (e.g., interaction 222) is drawn with two dots in between each dash to indicate, for example, that the corresponding processes (and/or interactions) may be one example of how subsequent steps might start but other subsequent steps to start the process.

At interaction 224 and as part of the identification process, management controller 152 may provide an information request to dependent data processing system 104A. The information request may be provided to dependent data processing system 104A via a point-to-point link 212. Point-to-point link 212 may be similar to point-to-point link 212 described in FIG. 2A.

For example, the information request may be provided to dependent data processing system 104A via (i) transmission via a message, (ii) storing in a storage with subsequent retrieval by dependent data processing system 104, (iii) via a publish-subscribe system where dependent data processing system 104A subscribes to updates from management controller 152 thereby causing a copy of the information request to be propagated to dependent data processing system 104A, and/or via other processes.

The information request may include, for example, a request for identifying data for dependent data processing system 104A. The request may include: (i) an identifier for management controller 152, (ii) request for an identifier for dependent data processing system, and/or (iii) other information usable to identify dependent data processing system 104A.

Following receipt of the information request, dependent data processing system 104A may perform request execution process 226. Request execution process 226 may include identifying the requested information (e.g., specified by information request) and generating a data package including the identifying information for the dependent data processing system (e.g., 104A).

At interaction 228, dependent data processing system 104A may provide the device data to management controller 152. Dependent data processing system 104A may provide the device data to management controller 152 via point-to-point link 212 thereby bypassing hardware resources 150.

For example, the device data may be provided to management controller 152 via (i) transmission via a message, (ii) storing in a storage with subsequent retrieval by management controller 152, (iii) via a publish-subscribe system where management controller 152 subscribes to updates from dependent data processing system 104A thereby causing a copy of the device data to be propagated to management controller 152, and/or via other processes.

Following receipt of the device data, at interaction 230, management controller 152 may extract the device identification information from the device data and generate a data structure including the device identification information and an identifier for data processing system 102 (e.g., more specifically an identifier for management controller 152). Device identification may be provided to cloud service system 100 by management controller 152. For example, the device identification may be provided to cloud service system 100 via (i) transmission via a message, (ii) storing in a storage with subsequent retrieval by cloud service system 100, (iii) via a publish-subscribe system where cloud service system 100 subscribes to updates from management controller 152 thereby causing a copy of the device information to be propagated to cloud service system 100, and/or via other processes.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1A-1B may perform various methods to manage endpoint devices. FIGS. 3A-3B illustrates methods that may be performed by the components of FIGS. 1A-1B. In the diagrams discussed below and shown in FIGS. 3A-3B, any of the operations may be repeated, performed in different orders, and/or performed in parallel with or in a partially overlapping in time manner with other operations.

Turning to FIG. 3A, a flow diagram illustrating a method of managing operations of a data processing system in accordance with an embodiment is shown. The method may be performed, for example, by any of the components of the system shown in FIGS. 1A-1B.

Prior to operation 300, a dependent data processing system may have been registered with a remote cloud server to facilitate communication between the dependent data processing system and the remote cloud server. Refer to FIG. 3B for additional details regarding registering a dependent data processing system.

At operation 300, a data request may be obtained. The data request may indicate that the management controller is an intermediate destination and a dependent data processing system operably connected to the management controller via a point-to-point communication link is a final destination. Obtaining the data request may include receiving, by a management controller of the data processing system and via a communication channel (e.g., the out-of-band communication channel), as a message from a remote cloud server. Obtaining the data request may include: (i) reading the data request from storage, (ii) receiving the data request as a transmission (via a network module of the data processing system) from the remote cloud server, and/or (iii) other methods.

At operation 302, the point-to-point communication link may be identified based on the management controller not being the final destination for the data request. The point-to-point communication link may be identified based on the dependent data processing system being the final destination.

Identifying the point-to-point communication link may include: (i) obtaining, by the management controller, a payload from the data request, (ii) identifying, by the management controller, a header in the payload, (iii) using, by the management controller, presence of an identifier of the final destination in the payload, (iv) based on the identifier, identifying the point-to-point communication link, and/or (v) other methods.

Obtaining the payload from the data request may include: (i) reading the payload from storage, (ii) receiving the payload as a transmission (via a network module of the data processing system) from the remote cloud server, and/or (iii) other methods.

Identifying the header in the payload may include analyzing the payload and identifying instruction regarding the content included in the payload. For example, identifying the header may include identifying a first portion of the payload being additional control information indicating the final destination and a second portion of the payload being the requested data.

Using presence of the identifier may include identifying the identifier (e.g., a global identifier) of the final destination in the payload and performing identification processes with the identifier.

Identifying the point-to-point communication link may include performing a lookup using: (i) the identifier of the final destination as a key for the lookup and, (ii) a lookup data structure that associates different final destinations with different point-to-point communication links and the different point-to-point communication links operably connecting the management controller to dependent data processing system.

At operation 304, the data request may be forwarded, using the point-to-point communication link, to the dependent data processing system to facilitate cooperative provisioning of a computer implemented service provided, at least in part, by the dependent data processing system.

Forwarding the data request may include: (i) extracting the final destination from the payload to identify the point-to-point communication link associated with the final destination, (ii) removing the header and the first portion of the payload to obtain a modified data request, and/or (iii) providing, via the out-of-band communication channel, the modified data request and the point-to-point communication link to a network module.

Extracting the final destination from the payload may include: (i) identifying the final destination based on the first portion of the payload being additional control information that indicates the final destination, (ii) generating, in response to the identifying, a copy of the final destination to use in performing a look up process in order to identify the point-to-point communication link, and/or (iii) other methods.

Removing the header and the first portion of the payload may include: (i) identifying the header and the first portion of the payload, (ii) generating, in response to the identifying, a modified data request including the second portion of the payload, and/or (iii) other methods.

Providing the modified data request and the point-to-point communication link to the network module may include: (i) transmitting, via the out-of-band communication channel, the modified data request and the point-to-point communication link to the network module of the data processing system, (ii) storing the modified data request and the point-to-point communication link in a storage architecture shared with the network module and notifying the network module that the modified data request and the point-to-point communication link is available in the shared storage architecture, and/or (iii) other methods.

The method may end following operation 304.

Thus, using the method shown in FIG. 3A, embodiments disclosed herein may facilitate communication between network-based devices (operably connected via a network) and non-network devices (e.g., devices not operably connected to any networks).

Turning to FIG. 3B, a flow diagram illustrating a method of managing operations of a data processing system in accordance with an embodiment is shown. The method may be performed, for example, by a data processing system, any components of a data processing system (e.g., a management controller, hardware resources, etc.), and/or any other entity.

At operation 306, an identity of the dependent data processing system may be obtained via the point-to-point communication link. Obtaining the identity of the dependent data processing system may include: (i) providing, via the point-to-point communication link, a request for identifying information to the dependent data processing system, (ii) receiving, via the point-to-point communication link and in response to the providing, a data package including an identifier (e.g., global identifier usable to identify a device) for the dependent data processing system, and/or (iii) other methods.

At operation 308, the identity of the dependent data processing system may be provided to the remote cloud server using the out-of-band communication channel to facilitate future communication between the dependent data processing system and the remote cloud server even while the dependent data processing system and the remote cloud server are not connected via a network. Providing the identity of the dependent data processing system to the remote cloud server may include: (i) transmitting, via the out-of-band communication channel, the identity via the network module of the data processing system, (ii) storing the identity in a storage architecture shared with the remote cloud server and notifying the remote cloud server that the identity is available in the shared storage architecture, and/or (iii) other methods.

Any of the components illustrated in FIGS. 1A-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data processing system, the method comprising:
obtaining, by a management controller of the data processing system and via an out-of-band communication channel, a data request indicating that the management controller is an intermediate destination and a dependent data processing system operably connected to the management controller via a point-to-point communication link is a final destination, the dependent data processing system being external to the data processing system and being a separate and independently operating computing device from both the management controller and the data processing system;
based on the management controller not being the final destination for the data request, identifying, by the management controller, the point-to-point communication link based on the dependent data processing system being the final destination; and
forwarding, by the management controller and using the point-to-point communication link, the data request to the dependent data processing system to facilitate cooperative provisioning of a computer implemented service provided, at least in part, by the dependent data processing system.

2. The method of claim 1, wherein the data processing system comprises a single network module that is shared by both of the management controller and hardware resources of the data processing system, the single network module being adapted to separately advertise network endpoints for the management controller and the hardware resources.

3. The method of claim 2, wherein the management controller and the single network module are on separate power domains from the hardware resources so that the management controller and the network module are operable while the hardware resources are inoperable.

4. The method of claim 2, wherein the out-of-band communication channel runs through the single network module, and an in-band communication channel that services the hardware resources also runs through the network module.

5. The method of claim 2, wherein the single network module hosts a transmission control protocol/internet protocol (TCP/IP) stack to facilitate network communications via the out-of-band communication channel.

6. The method of claim 1, wherein the data request is obtained from a remote cloud server, the remote cloud server and the data processing system being operably connected to each other via a network, and the remote cloud server is not operably connected to the dependent data processing system by any wide area or telecommunications-based networks.

7. The method of claim 6, wherein the intermediate destination is a bridge for communications between the remote cloud server and the dependent data processing system.

8. The method of claim 1, wherein identifying the point-to-point communication link comprises:
obtaining, by the management controller, a payload from the data request;
identifying, by the management controller, a header in the payload;
using, by the management controller, presence of an identifier of the final destination in the payload; and
based on the identifier, identifying the point-to-point communication link.

9. The method of claim 8, wherein the point-to-point communication link is identified by using the identifier as a key for a lookup, the lookup being performed using a lookup data structure that associates different final destinations with different point-to-point communication links, and the different point-to-point communication links operably connecting the management controller to dependent data processing systems.

10. The method of claim 9, wherein the point-to-point communication link is a direct communication link that allows transmission of information between the management controller and the dependent data processing system without using any wide area or telecommunications-based networks.

11. The method of claim 1, wherein the data request comprises a payload, and a header identifying a first portion of the payload being additional control information indicating the final destination and a second portion of the payload being the requested data.

12. The method of claim 11, wherein forwarding the data request comprises:
extracting, by the management controller, the final destination from the payload to identify the point-to-point communication link associated with the final destination;
removing, by the management controller, the header and the first portion of the payload to obtain a modified data request; and
providing, by the management controller and via the out-of-band communication channel, the modified data request and the point-to-point communication link to a network module.

13. The method of claim 1, further comprising:
prior to obtaining the data request:
obtaining, by the management controller and via the point-to-point communication link, an identity of the dependent data processing system; and
providing, by the management controller and via the out-of-band communication channel, the identity of the dependent data processing system to a remote cloud server for the management controller to be, as a proxy for the dependent data processing system, a facilitator of future communications between the dependent data processing system and the remote cloud server while the dependent data processing system and the remote cloud server are not directly connected to one another via any wide area or telecommunications-based networks.

14. A non-transitory machine-readable medium having instructions stored therein, which when executed by a processor, cause the processor to perform operations for managing operation of a data processing system, the operations comprising:
obtaining, by a management controller of the data processing system and via an out-of-band communication channel, a data request indicating that the management controller is an intermediate destination and a dependent data processing system operably connected to the management controller via a point-to-point communication link is a final destination, the dependent data processing system being external to the data processing system and being a separate and independently operating computing device from both the management controller and the data processing system;
based on the management controller not being the final destination for the data request, identifying, by the management controller, the point-to-point communication link based on the dependent data processing system being the final destination; and
forwarding, by the management controller and using the point-to-point communication link, the data request to the dependent data processing system to facilitate cooperative provisioning of a computer implemented service provided, at least in part, by the dependent data processing system.

15. The non-transitory machine-readable medium of claim 14, wherein the data processing system comprises a network module adapted to separately advertise network endpoints for the management controller and hardware resources of the data processing system, the network endpoints being usable by a server to address communications to the hardware resources using an in-band communication channel and the management controller using the out-of-band communication channel.

16. The non-transitory machine-readable medium of claim 15, wherein the data processing system comprises a network module adapted to separately advertise network endpoints for the management controller and hardware resources of the data processing system, the network endpoints being usable by a server to address communications to the hardware resources using an in-band communication channel and the management controller using the out-of-band communication channel.

17. A data processing system, comprising:
a processor; and
a memory coupled to the processor to store instructions, which when executed by the processor, cause the processor to perform operations for managing operation of a data processing system, the operations comprising:
obtaining, by a management controller of the data processing system and via an out-of-band communication channel, a data request indicating that the management controller is an intermediate destination and a dependent data processing system operably connected to the management controller via a point-to-point communication link is a final destination, the dependent data processing system being external to the data processing system and being a separate and independently operating computing device from both the management controller and the data processing system;
based on the management controller not being the final destination for the data request, identifying, by the management controller, the point-to-point communication link based on the dependent data processing system being the final destination; and
forwarding, by the management controller and using the point-to-point communication link, the data request to the dependent data processing system to facilitate cooperative provisioning of a computer implemented service provided, at least in part, by the dependent data processing system.

18. The data processing system of claim 17, wherein the data processing system comprises a network module adapted to separately advertise network endpoints for the management controller and hardware resources of the data processing system, the network endpoints being usable by a server to address communications to the hardware resources using an in-band communication channel and the management controller using the out-of-band communication channel.

19. (canceled)

20. (canceled)

21. The method of claim 2, wherein the single network module is adapted to separately advertise network endpoints for the management controller and the hardware resources such that first network communications directed to the hardware resources never flow through the management controller and second network communications directed to the management controller never flow through the hardware resources.

22. The method of claim 21, wherein the network endpoints are usable by a server to separately address the hardware resources and the management controller as two separate and independently operating computing devices contained within a body of the data processing system.
